(19) United States
(12) Patent Application Publication
(10) Pub. No.: US 2017/0146682 A1
(43) Pub. Date: May 25, 2017

(54) SYSTEMS AND METHODS FOR IDENTIFYING ANOMALOUS RADIATION MEASUREMENTS

(71) Applicant: BOARD OF REGENTS, THE UNIVERSITY OF TEXAS SYSTEM, Austin, TX (US)

(72) Inventors: Alex Athey, Austin, TX (US); Patrick Vetter, Austin, TX (US); Alex Reinhart, Boerne, TX (US)

(21) Appl. No.: 15/117,031

(22) PCT Filed: May 1, 2014
(86) PCT No.: PCT/US2014/036350

§ 371 Date: Aug. 5, 2016

Related U.S. Application Data
(60) Provisional application No. 61/936,522, filed on Feb. 6, 2014.

(51) Int. Cl. G01V 5/00; G01T 1/167; G01T 7/00

(52) U.S. Cl. CPC G01V 5/0075; G01T 7/00; G01T 1/167

(57) ABSTRACT

An example method for identifying anomalous radiation measurements acquired in a geographic region can include receiving a radiation measurement for a location within the geographic region, where the radiation measurement is associated with location and time data. The method can also include calculating a background radiation measurement for the location, as well as an expected variation in the background radiation measurement, using a spatial-spectral-temporal database that includes a plurality of radiation measurement records for the geographic region. Each of the radiation measurement records can include a respective radiation measurement that is associated with location and time data. The method can further include comparing the radiation measurement with the background radiation measurement and the expected variation, and determining whether the radiation measurement is anomalous based on the comparison.

### CROSS-REFERENCE TO RELATED APPLICATIONS

This application claims the benefit of U.S. Provisional Application No. 61/936,522, filed Feb. 6, 2014, which is hereby incorporated herein by reference in its entirety.

### STATEMENT REGARDING FEDERALLY FUNDED RESEARCH

This invention was made with Government support under Contract N00024-07-D-6200, Task Order 00379, Task Description 7101009 awarded by the Office of the Assistant Secretary of Defense for Nuclear Matters. The Government has certain rights in the invention.

### BACKGROUND

Wide-area radiation surveillance is a challenging problem for environmental and security applications. For example, a city may wish to produce a map of radiation sources over a wide region, identify unexpected or unauthorized radioactive sources and take corrective action, then monitor the area for any future introduction of sources. Conventional radiation mapping systems, however, are inadequate for providing radiation surveillance for wide areas. For example, some conventional radiation mapping systems focus on one-time mapping, rather than continuous monitoring and surveillance. Additionally, other conventional radiation mapping systems rely on several weeks of intensive aerial surveys, which makes them inadequate for continuous monitoring of a wide area in real-time. Further, conventional radiation detection systems also prove unsuitable for wide-area radiation surveillance applications, for example, due to their failure to perform change detection from one survey to the next, as well as their failure to use previous background observations to improve detection sensitivity.

### SUMMARY

The ability to continuously monitor wide areas for unexpected changes in radioactivity is desirable, in particular for security, environmental, or regulatory purposes. Described herein are systems and methods for detecting anomalous radiation measurements. The systems and methods use one or more mobile radiation detectors to collect radiation measurements in a geographic region and then build a spatial map of background radiation levels based on the collected radiation measurements. The mobile radiation detectors are used to perform multi-pass radiation surveys in the geographic region. The systems and methods perform anomaly detection by comparing a new radiation measurement for a location within the geographic region to a background radiation measurement for the location, which is calculated from the previously-collected radiation measurements for the location. Because spatial variance is larger than temporal variance, the systems and methods can deliver increased sensitivity to weak or distant sources. This allows for sensitive detection of anomalies throughout days, weeks, months, years, etc. of monitoring. In addition, according to some implementations, the systems and methods modify previously-developed anomaly detection algorithms that compare spectral shape (e.g., rather than count rate) in order to function with limited background radiation data. This allows for a consistency treatment of geographic areas with different amounts of data and enables sensitive detection of small changes in spectral shape over time, even with limited background data.

An example method for identifying anomalous radiation measurements acquired in a geographic region can include receiving a radiation measurement for a location within the geographic region, where the radiation measurement is associated with location and time data. The method can also include calculating a background radiation measurement for the location, as well as an expected variation in the background radiation measurement, using a spatial-spectral-temporal database that includes a plurality of radiation measurement records for the geographic region. Each of the radiation measurement records can include a respective radiation measurement that is associated with location and time data. The method can further include comparing the radiation measurement with the background radiation measurement and the expected variation, and determining whether the radiation measurement is anomalous based on the comparison.

Additionally, the method can include dividing the geographic region into a plurality of cells, and identifying a particular cell containing the location. The background radiation measurement can then be calculated by collecting respective radiation measurements for the radiation measurement records contained in the spatial-spectral-temporal database that are associated with the particular cell. Optionally, each of the cells is 250 m×250 m.

Alternatively or additionally, the radiation measurement can be compared with the background radiation measurement and the expected variation by performing a spectral comparison between spectral content of the radiation measurement and spectral content of the background radiation measurement. For example, the step of performing a spectral comparison can include dividing an energy spectrum into a plurality of energy bins, and for each of the radiation measurement and the background radiation measurement, summing a number of counts having a respective energy level associated with each of the energy bins. Then, the number of counts for the radiation measurement having the respective energy level associated with each of the energy bins can be compared with the number of counts for the background radiation measurement having the respective energy level associated with each of the energy bins. Optionally, the energy bins can be distributed evenly across the energy spectrum. Alternatively, the energy bins can be distributed across the energy spectrum to cover targeted spectral region(s) and/or targeted isotope(s).

Alternatively or additionally, the expected variation in the background radiation measurement can be calculated by dividing an energy spectrum into a plurality of energy bins, and for each of a plurality of discrete time intervals, summing a number of counts associated with one or more of the radiation measurement records contained in the spatial-spectral-temporal database having a respective energy level associated with one of the energy bins. Then, correlations between the number of counts having the respective energy level associated with the energy bin over the discrete time intervals can be calculated, and a covariance between the number of counts having the respective energy level associated with the energy bin over the discrete time intervals can be estimated based on the correlations. Optionally, the radiation measurement records used to calculate the expected variation can include all of the radiation measurement records contained in the spatial-spectral-temporal database (e.g., all of the radiation measurement records associated with the geographic region). Alternatively, the radiation measurement records used to calculate the expected variation can include only the radiation measurement records associated with locations within a sub-region of the geographic region (e.g., only the radiation measurement records associated with a cell (or multiple cells) of the geographic region).

Additionally, the step of determining whether the radiation measurement is anomalous based on the comparison can include determining whether a change between the spectral content of the radiation measurement and the spectral content of the background radiation measurement is consistent with the expected variation in the background radiation measurement, for example, by calculating a vector difference. In addition, the change between the spectral contents of the radiation measurement and the background radiation measurement is consistent with the expected variation under the condition that the vector difference is less than or equal to a predetermined threshold value. Alternatively or additionally, the change between the spectral contents of the radiation measurement and the background radiation measurement is not consistent with the expected variation under the condition that the vector difference is greater than a predetermined threshold value. In addition, the vector difference can be greater than the predetermined threshold value due to an increase or decrease in radioactivity within the geographic region. Alternatively or additionally, the predetermined threshold can be derived from the expected variation in the background radiation measurement.

Alternatively or additionally, the method can further include creating and maintaining the spatial-spectral-temporal database by performing multi-pass radiation measurement surveys within the geographic region. Additionally, the method can optionally further include storing the radiation measurement in the spatial-spectral-temporal database, or alternatively, transmitting the radiation measurement to another device for storage in the spatial-spectral-temporal database.

Alternatively or additionally, the method can further include generating an alarm in response to determining that the radiation measurement for the location is anomalous.

An example system for identifying anomalous radiation measurements acquired in a geographic region can include a detection system including a radiation detector configured for acquiring radiation measurements, a location detection device configured for acquiring location data associated with the radiation measurements, and a timing device configured for acquiring time data associated with the radiation measurements. The example system can also include a computing device having a processor and memory operably coupled to the processor. The computing device can be configured to receive a radiation measurement for a location within the geographic region from the detection system, where the radiation measurement is associated with location and time data. The computing device can also be configured to calculate a background radiation measurement for the location, as well as an expected variation in the background radiation measurement, using a spatial-spectral-temporal database that includes a plurality of radiation measurement records for the geographic region. Each of the radiation measurement records can include a respective radiation measurement that is associated with location and time data. The computing device can be further configured to compare the radiation measurement with the background radiation measurement and the expected variation, and determine whether the radiation measurement is anomalous based on the comparison.

Optionally, the computing device can be configured to create and maintain the spatial-spectral-temporal database based on multi-pass radiation measurement surveys performed within the geographic region. For example, the system can optionally include a plurality of detection systems for collecting radiation measurements within the geographic regions. For example, respective detection systems can traverse the geographic region on regular or irregular paths while collecting the radiation measurements. These radiation measurements can be the multi-pass radiation measurement surveys. Alternatively or additionally, the computing device can be further configured to generate an alarm in response to determining that the radiation measurement for the location is anomalous. Optionally, the computing device can be further configured to transmit the alarm to the detection system. Alternatively or additionally, the computing device can optionally be further configured to transmit the alarm to a command center. The alarm can be configured to trigger at least one of an audio, visual or tactile alarm. Additionally, the computing device can optionally be configured to store the radiation measurement in the spatial-spectral-temporal database, or alternatively, to transmit the radiation measurement to another device for storage in the spatial-spectral-temporal database.

Additionally, the computing device can be configured to divide the geographic region into a plurality of cells, and identify a particular cell containing the location. The background radiation measurement can then be calculated by collecting respective radiation measurements for the radiation measurement records contained in the spatial-spectral-temporal database that are associated with the particular cell. Optionally, each of the cells is 250 m×250 m.

Alternatively or additionally, the radiation measurement can be compared with the background radiation measurement and the expected variation by performing a spectral comparison between spectral content of the radiation measurement and spectral content of the background radiation measurement. For example, the step of performing a spectral comparison can include dividing an energy spectrum into a plurality of energy bins, and for each of the radiation measurement and the background radiation measurement, summing a number of counts having a respective energy level associated with each of the energy bins. Then, the number of counts for the radiation measurement having the respective energy level associated with each of the energy bins can be compared with the number of counts for the background radiation measurement having the respective energy level associated with each of the energy bins. Optionally, the energy bins can be distributed evenly across the energy spectrum. Alternatively, the energy bins can be distributed across the energy spectrum to cover targeted spectral region(s) and/or targeted isotope(s).

Alternatively or additionally, the expected variation in the background radiation measurement can be calculated by dividing an energy spectrum into a plurality of energy bins, and for each of a plurality of discrete time intervals, summing a number of counts associated with one or more of the radiation measurement records contained in the spatial-spectral-temporal database having a respective energy level associated with one of the energy bins. Then, correlations between the number of counts having the respective energy level associated with the energy bin over the discrete time intervals can be calculated, and a covariance between the number of counts having the respective energy level associated with the energy bin over the discrete time intervals can be estimated based on the correlations. Optionally, the radiation measurement records used to calculate the expected variation can include all of the radiation measurement records contained in the spatial-spectral-temporal database (e.g., all of the radiation measurement records associated with the geographic region). Alternatively, the radiation measurement records used to calculate the expected variation can include only the radiation measurement records associated with locations within a sub-region of the geographic region (e.g., only the radiation measurement records associated with a cell (or multiple cells) of the geographic region).

Additionally, the step of determining whether the radiation measurement is anomalous based on the comparison can include determining whether a change between the spectral content of the radiation measurement and the spectral content of the background radiation measurement is consistent with the expected variation in the background radiation measurement, for example, by calculating a vector difference. In addition, the change between the spectral contents of the radiation measurement and the background radiation measurement is consistent with the expected variation under the condition that the vector difference is less than or equal to a predetermined threshold value. Alternatively or additionally, the change between the spectral contents of the radiation measurement and the background radiation measurement is not consistent with the expected variation under the condition that the vector difference is greater than a predetermined threshold value. In addition, the vector difference can be greater than the predetermined threshold value due to an increase or decrease in radioactivity within the geographic region. Alternatively or additionally, the predetermined threshold can be derived from the expected variation in the background radiation measurement.

It should be understood that the above-described subject matter may be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a block diagram of an example system for identifying anomalous radiation measurements as described herein.

FIG. 2 is a block diagram of an example computing device as described herein.

FIG. 3 is a diagram of a geographic region with dashed lines indicating the boundaries of geographic cells.

FIG. 4 is an example spectrum with vertical dashed lines indicating the boundaries of the energy bins (or spectral bins).

FIG. 5 is a graph illustrating the mean (solid line), minimum and maximum (dashed lines) index of dispersion of counts in each energy bin for all geographic cells of a geographic region at specified cell sizes. An index of 1 is consistent with a Poisson distribution. As shown in FIG. 5, smaller geographic cell sizes more closely match the Poisson distribution, while larger geographic cells sizes have additional variance.

FIG. 6 is a flow diagram illustrating example operations for identifying anomalous radiation measurements.

FIG. 7 is a map of a geographic region (e.g., a map of a university research campus) with gamma counts per second averaged over a one-month period overlaid. The areas of elevated background include a radioactive material storage facility at a northwest corner (at point “A”) and a cluster of large brick buildings near the center of the campus (at point “B”).

FIG. 8 is a graph illustrating the distribution of the spectral comparison ratio (“SCR”) anomaly statistic, D², in 250-meter geographic cells for a university research campus in an example data set, with an χ² distribution (with 7 degrees of freedom) overlaid.

FIG. 9 is a heatmap of the SCR values for a university research campus comparing one day to the previous days, with ρ values computed based on the χ² distribution of D². A simulated 275 mCi cesium-137 source was injected on the west side of the university research campus at point 902. The radiation detector traveled along an adjacent road, never closer than 100 m.

FIG. 10 is a graph illustrating a minimum cesium-137 source size required for detection at least 80% of the time at various distances away from a radiation detector's path using both temporal and spatial comparisons of spectra. The total observation time was 136 seconds.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. While implementations will be described for identifying anomalous radiation measurements, it will become evident to those skilled in the art that the implementations are not limited thereto.

Wide-area radiation surveillance is a challenging problem for environmental and security applications. For example, a city may wish to produce a map of radiation sources over a wide region, identify unexpected or unauthorized radioactive sources and take corrective action, then monitor the area for any future introduction of sources. Dedicated systems have been developed, such as the United States Department of Energy's Aerial Measuring System, which uses aircraft to map radiological activity at nuclear sites and during emergencies. Wasiolek, P., “An Aerial Radiological Survey of the City of North Las Vegas (Downtown) and the Las Vegas Motor Speedway,” Tech. Rep. DOE/NV/25946-352, December 2007; National Nuclear Security Administration, “Aerial Measuring System Factsheet.” http://www.nv.doe.gov/library/factsheets/AMS.pdf. This system, however, focuses on one-time mapping, rather than continuous monitoring and surveillance. For city-sized areas, current mapping efforts typically use low-flying helicopters. Although these operations produce high-resolution maps, these operations require several weeks of intensive flying, which makes them unsuitable for continuous monitoring of a wide area in real time.

Another method of mapping includes gamma-ray imaging devices mounted in vehicles. Zelakiewicz, S. et al., “SORIS—A standoff radiation imaging system,” Nuclear Instruments and Methods in Physics Research Section A, vol. 652, pp. 5-9, October 2011. Yet another method of mapping includes using a mobile scintillator detector to search for sudden changes in background spectral shape, indicating the detector is traveling past a source. Pfund, D. M. et al., “Examination of Count-Starved Gamma Spectra Using the Method of Spectral Comparison Ratios,” IEEE Transactions on Nuclear Science, vol. 54, pp. 1232-1238, August 2007; Pfund, D. M. et al., “Low Count Anomaly Detection at Large Standoff Distances,” IEEE Transactions on Nuclear Science, vol. 57, no. 1, pp. 309-316, 2010. However, these techniques do not perform change detection from one survey to the next, and moreover, do not take advantage of previous background observations to improve detection sensitivity. In addition, imaging methods require large and expensive detectors and focus on detecting and imaging individual sources, rather than mapping large areas. Therefore, systems and methods for providing wide-area radiation surveillance are described below.

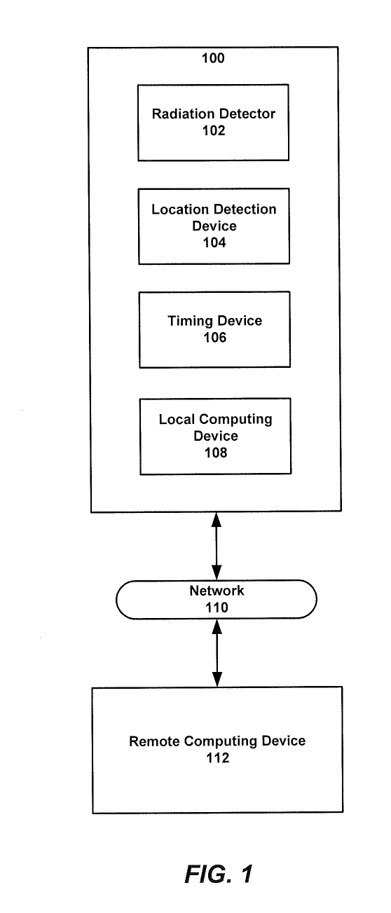

Referring now to FIG. 1, a block diagram of an example system for identifying anomalous radiation measurements is shown. The example system is sometimes referred to as a spectral comparison ratio anomaly mapping (“SCRAM”) system below. The detection system 100 can optionally be a mobile detection system. For example, the detection system 100 can be carried on a vehicle that transits areas of interest (e.g., a geographic area or region) during routine operations, such as automobiles (e.g., patrol vehicles, utility vehicles, etc.), buses, boats, aircraft or unmanned aerial vehicles. Alternatively or additionally, the detection system 100 can be hand-carried through the areas of interest, for example, by law enforcement or military personnel or any other person (i.e., the detection system 100 can optionally be a hand-held detection system). The detection system 100 can include a radiation detector 102 configured for acquiring radiation measurements, a location detection device 104 configured for acquiring location data associated with the radiation measurements, and a timing device 106 configured for acquiring time data associated with the radiation measurements. Although a single radiation detector is shown in FIG. 1, this disclosure contemplates that the system can include a plurality of radiation detectors.

The radiation detector 102 can be configured to measure raw counts and/or radiation spectra (e.g., counts with associated energy levels). For example, the radiation detector 102 can optionally be a scintillation detector such as a universal serial bus (“USB”)-based 2 inch by 2 inch cesium iodide scintillation detector from BRIDGEPORT INSTRUMENTS, LLC of AUSTIN, TEXAS. Although a scintillation detector is provided as an example, this disclosure contemplates using other types of radiation detectors including, but not limited to, other types of gamma ray or neutron detectors. The location detection device 104 can be configured to acquire the location of the detection system 100 when the radiation measurement is collected. In other words, the location detection device 104 can acquire position information such as latitude and longitude (or geographic coordinates), for example, and the position information can be associated with a particular radiation measurement. For example, the location detection device 104 can optionally be a USB-based global positioning system (“GPS”) device. Although a GPS location device is provided as an example, this disclosure contemplates using other types of location detection devices, including but not limited to, devices using multilateration of broadcast signals. In addition, the timing device 106 can be configured to acquire time data. The timing device 106 can be a clock, for example. The timing device 106 can acquire time information such as time of day (e.g., YYYYMMDDHHMMSS) and the time information can be associated with a particular radiation measurement.

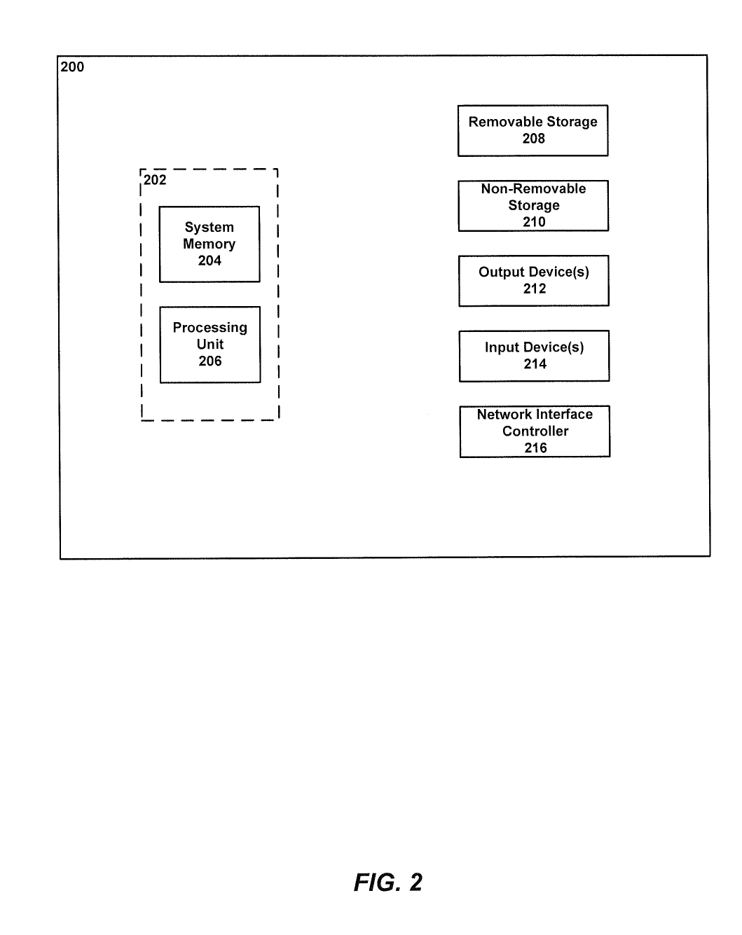

Additionally, the detection system 100 can include a local computing device 108. One or more features of the local computing device 108 are described below with regard to FIG. 2. Optionally, the local computing device 108 can be a laptop computer, tablet computer, personal digital assistant, mobile phone, etc., for example. The radiation detector 102, the location detection device 104 and/or the timing device 106 can be communicatively connected to the local computing device 108 through one or more communication links. This disclosure contemplates the communication links are any suitable communication link. For example, a communication link may be implemented by any medium that facilitates data exchange between the radiation detector 102, the location detection device 104 and/or the timing device 106 including, but not limited to, wired, wireless and optical links. The local computing device 108 can be configured to receive and process, and optionally store, radiation measurements associated with respective location and time information (e.g., radiation measurements tagged with geographic coordinate data and time of day information).

In addition to the detection system 100, the system can optionally include a remote computing device 112. One or more features of the remote computing device 112 are described below with regard to FIG. 2. For example, the detection system 100 can be communicatively connected to the remote computing device 112 through a network 110. This disclosure contemplates that the network 110 can be one or more suitable communication networks. The networks can be similar to each other in one or more respects. Alternatively or additionally, the networks can be different from each other in one or more respects. The networks can include a local area network (LAN), a wireless local area network (WLAN), a wide area network (WAN), a metropolitan area network (MAN), a virtual private network (VPN), etc., including portions or combinations of any of the above networks. The detection system 100 and the remote computing device 112 can be coupled to the network 110 through one or more communication links. This disclosure contemplates the communication links are any suitable communication link. For example, a communication link may be implemented by any medium that facilitates data exchange between the detection system 100 and the remote computing device 112 including, but not limited to, wired, wireless and optical links. Example communication links include, but are not limited to, a LAN, a WAN, a MAN, Ethernet, the Internet, or any other wired or wireless link such as WiFi, WiMax, 3G or 4G. Similar to the local computing device 108, the remote computing device 112 can be configured to receive and process, and optionally store, radiation measurements associated with respective location and time information (e.g., radiation measurements tagged with geographic coordinate data and time of day information).

As described above, a radiation measurement acquired by the radiation detector 102 can be tagged or associated with location data (e.g., geographic coordinates) acquired by the location detection device 104 and time data (e.g., TOD information) acquired by the timing device 106. The radiation measurement, as well at the location and time data, can be stored in a spatial-spectral-temporal database, for example. Optionally, other information or data fields can be stored along with the radiation measurement in the spatial-spectral-temporal database such as temperature, humidity, radiation detector gain settings, location positional error (e.g., GPS positional error), elevation, total operational time, etc. In other words, the spatial-spectral-temporal database can include a plurality of radiation measurement records for the geographic region, where each of the radiation measurement records includes a respective radiation measurement tagged or associated with location and time data. The spatial-spectral-temporal database can be designed to facilitate rapid querying of radiation measurements based on a location (e.g., a geographic coordinate or range of geographic coordinates) and/or a time (e.g., a specific time or range of times). Databases are well-known in the art and are therefore not described in detail herein.

The spatial-spectral-temporal database can be built by performing multi-pass radiation measurement surveys within a geographic region. As used herein, a geographic region can be any geographic area. Optionally, a geographic region can be a wide area such as a city, a region, a state, etc. or any portion thereof. For example, as described below, the geographic region can be a university research campus. This disclosure contemplates that the geographic region should not be limited to the examples provided below and that the geographic region can be any defined geographic area in which radiation levels are monitored, regardless of size and/or geo-political boundaries. The multi-pass radiation measurement surveys can include collecting radiation measurements with one or more radiation detection systems (e.g., the detection system 100 shown in FIG. 1). For example, the radiation detection system(s) can be attached or carried on persons and/or vehicles that traverse the geographic region on regular or irregular routes, for example. During traversal, the radiation detection system(s) can collect radiation measurements, which are tagged or associated with respective location and time data. The radiation detection system(s) can collect radiation measurements within the geographic region over extended periods of time such as days, weeks, months, years, etc. The radiation measurements tagged with respective location and time data collected by the radiation detection system(s) can be stored in the spatial-spectral-temporal database. As described in detail below, the spatial-spectral-temporal database can be used to calculate (or measure) the background radiation levels, as well as the variation thereof, for the geographic region. Then, new radiation measurements collected within the geographic region can be compared with the expected background radiation levels and anomalous radiation levels can therefore be detected.

The spatial-spectral-temporal database can be stored or maintained by one or more computing devices such as the local computing device 108 or the remote computing device 112 described with regard to FIG. 1. For example, the spatial-spectral-temporal database can optionally be maintained by the remote computing device 112. In this implementation, the radiation measurements collected by the detection system 100 can be transmitted from the local computing device 108 to the remote computing device 112 over the network 110 for storage in the spatial-spectral-temporal database. It should be understood, however, that this implementation is provided only as an example. This disclosure contemplates that the storage location and/or the computing device that maintains the spatial-spectral-temporal database can be selected by a system administrator.

When the logical operations described herein are implemented in software, the process may execute on any type of computing architecture or platform. For example, referring to FIG. 2, the example computing device upon which embodiments of the invention may be implemented is illustrated. The local computing device 108 and/or the remote computing device 112 described above with regard to FIG. 1 can include one or more of the features of computing device 200. The computing device 200 may include a bus or other communication mechanism for communicating information among various components of the computing device 200. In its most basic configuration, computing device 200 typically includes at least one processing unit 206 and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the computing device 200.

Computing device 200 may have additional features/functionality. For example, computing device 200 may include additional storage such as removable storage 208 and non-removable storage 210 including, but not limited to, magnetic or optical disks or tapes. Computing device 200 may also contain network connection(s) 216 that allow the device to communicate with other devices. Computing device 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computing device 200. All these devices are well known in the art and need not be discussed at length here.

The processing unit 206 may be configured to execute program code encoded in tangible, computer-readable media. Computer-readable media refers to any media that is capable of providing data that causes the computing device 200 (i.e., a machine) to operate in a particular fashion. Various computer-readable media may be utilized to provide instructions to the processing unit 206 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

Computing device 200 typically includes a variety of computer-readable media. Computer-readable media can be any available media that can be accessed by device 200 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 204, removable storage 208, and non-removable storage 210 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 200. Any such computer storage media may be part of computing device 200.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

As described above, the background radiation level (e.g., the background radiation measurement as used herein) for a particular location within the geographic region can be calculated from the radiation measurement records contained in the spatial-spectral-temporal database. An example technique for calculating the background radiation measurement using the spatial-spectral-temporal database is described in detail below. Additionally, an expected variation of the background radiation level can also be measured from the radiation measurement records contained in the spatial-spectral-temporal database. As used herein, measuring the expected variation involves measuring or calculating variation based on the radiation measurement records contained in the spatial-spectral-temporal database, as opposed to merely estimating the expected variation in the background radiation level from a radiation measurement, for example, by assuming that the expected variation in the background radiation level is consistent with the Poisson distribution. An example technique for measuring the expected variation in the background radiation measurement using the spatial-spectral-temporal database is described in detail below. In addition, after calculating the background radiation level for the particular location, as well as the expected variation thereof, a new radiation measurement collected at the particular location within the geographic region can be compared with the calculated background radiation level and the measured expected variation for the particular location, and based on this comparison, it is possible to determine whether the new radiation measurement collected at the particular location is anomalous, for example, using any of the anomaly detection techniques described herein.

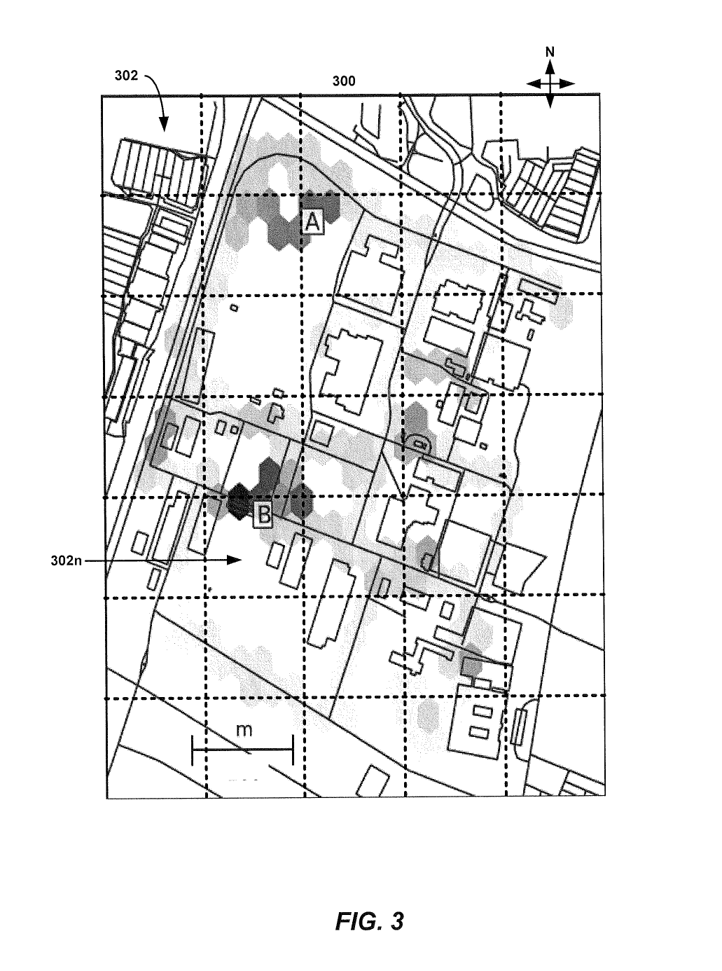

An example technique for calculating the background radiation level for a particular location within a geographic region is now provided. Referring now to FIG. 3, the geographic region 300 is an example university research campus (e.g., University of Texas's J. J. Pickle Research Campus as described below). The geographic region 300 can be divided into a plurality of cells 302. The dashed lines in FIG. 3 indicate the boundaries between the cells of the geographic region. For example, each of the cells can be a 250 m by 250 m cell. It should be understood, however, that the dimensions of the cells should not be limited to 250 m by 250 m and can have other dimensions. After dividing the geographic region, a particular cell containing the particular location for which the background radiation level will be calculated can be identified. For example, assuming that the background radiation level will be calculated for point “B” in FIG. 3, cell 302n can be identified because it contains the location (e.g., point “B”) for which the background radiation level will be calculated. The spatial-spectral-temporal database can then be queried for the radiation measurement records that are associated with location data (e.g., a geographic coordinate) within cell 302n. As described above, the radiation measurement records include respective radiation measurements tagged or associated with location and time data, and therefore, the spatial-spectral-temporal database can be queried based on a range of geographic coordinates for cell 302n in order to obtain the desired radiation measurement records (e.g., those radiation measurement records previously collected within cell 302n). The background radiation measurement for point “B” in FIG. 3 can then be calculated from the radiation measurement records returned in response to the query, for example, by collecting (or aggregating) the respective radiation measurements for these records. The background radiation measurement can optionally be calculated based on raw counts. Alternatively, the background radiation measurement can optionally be calculated based on spectra information (e.g., counts with associated energies). For example, the respective radiation measurements for the queried radiation measurement records can optionally be summed (e.g., the integration times over the cell of the geographic region can be summed). In addition, the mean number of counts for one or more of the energy bins relative to the total number of counts for all of the energy bins can optionally be calculated. By querying and collecting radiation measurement records associated with location data within the cell 302n from the spatial-spectral-temporal database, the background radiation measurement for point “B” in FIG. 3 can be calculated only from radiation measurements previously collected within cell 302n, i.e., the radiation measurements collected at locations in spatial-proximity to point “B” in FIG. 3.

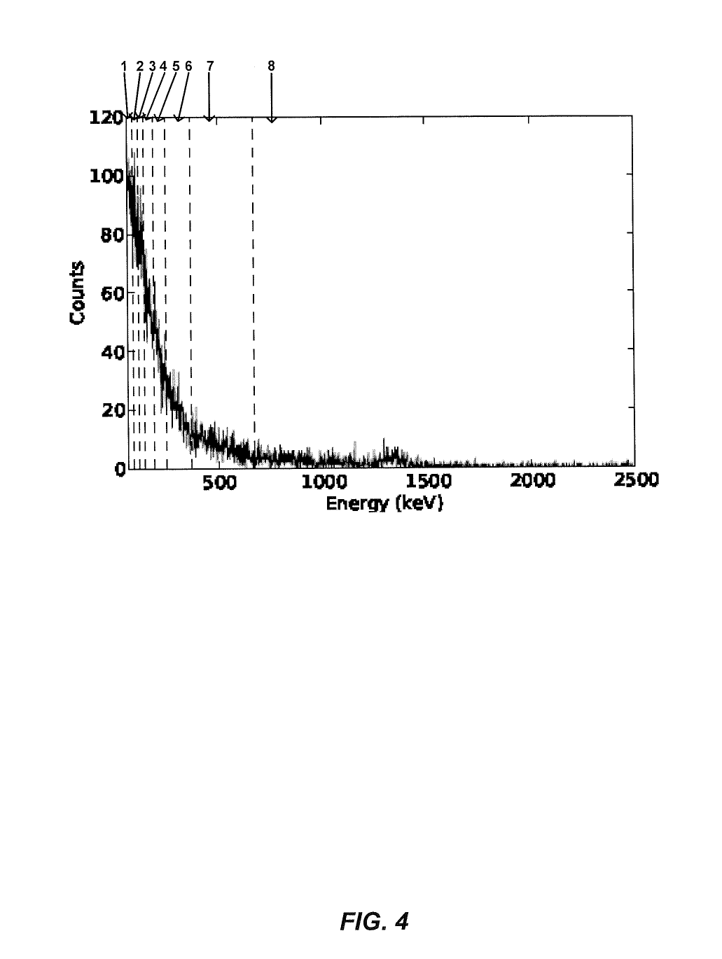

Additionally, in some implementations, the spectral content of a new radiation measurement collected at a particular location within the geographic region (i.e., instead of the total number of counts) can be compared with the spectral content of the background radiation measurement for the particular location within the geographic region. This type of comparison is referred to herein as a spectral comparison. Similar to above, the particular location within the geographic region can be point “B” in FIG. 3, which is located in cell 302n. Additionally, as used herein, a “new radiation measurement” is the radiation measurement that will be compared with the background radiation measurement in order to determine whether it is anomalous. As described above, a radiation detector such as the radiation detector 102 shown in FIG. 1 can measure radiation spectra, e.g., counts with associated energy levels, which can be stored in the spatial-spectral-temporal database. In order to perform a spectral comparison, the energy spectrum can be divided into a plurality of energy bins. Referring to FIG. 4, an example spectrum with vertical dashed lines indicating the boundaries of the energy bins (e.g., energy bins 1-8) is shown. In FIG. 4, eight energy bins are provided between approximately 100 keV and 2500 keV, where each of the eight energy bins contains an approximately equal number of counts in a typical background spectrum. In other words, the eight energy bins are distributed evenly across the spectrum such that each bin contains roughly the same number of counts. It should be understood that the number of bins and/or distribution across the spectrum can be different than the example shown in FIG. 4, which include, but should not be limited to, the following example bin distribution techniques. For example, the energy bins can be distributed across the spectrum to target one or more spectral regions or isotopes. In some implementations, this disclosure contemplates distributing energy bins to target specific isotope and/or reject specific nuisance isotopes. Pfund, D. M. et al., “Low Count Anomaly Detection at Large Standoff Distances,” IEEE Transactions on Nuclear Science, vol. 57, no. 1, pp. 309-316, 2010; Wei, W. et al., “Particle Swarm Optimization Based Spectral Transformation for Radioactive Material Detection and Classification,” in 2010 IEEE International Conference on Computational Intelligence for Measurement Systems and Applications (CIMSA), pp. 1-6, IEEE, 2010. Alternatively, this disclosure contemplates distributing the energy bins across the spectrum such that the width of each energy bin is proportional to a square root of energy. Jarman, K. D. et al., “A comparison of simple algorithms for gamma-ray spectrometers in radioactive source search applications,” Applied Radiation and Isotopes, vol. 66, pp. 362-371, March 2008.

After binning the spectrum as described above, the number of counts with respective energy levels within each of the energy bins for the new radiation measurement for the particular location (e.g., point “B” in FIG. 3 within cell 302n) can be summed. In other words, with reference again to FIG. 4, the number of counts for the new radiation measurement having energy levels within each of a first, second, third, . . . and eighth energy bins (e.g., bins 1-8) can be summed. Similar to the new radiation measurement, the same process can be performed for the background radiation measurement, which can be calculated from the radiation measurement records contained in the spatial-spectral-temporal database that are associated with locations (e.g., geographic coordinates) within the particular cell of the geographic region (e.g., the radiation measurement records previously collected within cell 302n in FIG. 3). A spectral comparison can then be performed for the new radiation measurement and the background radiation measurement.

A spectral comparison can be performed by comparing the respective spectral shapes of the new radiation measurement and the background radiation measurement for the particular location. For example, spectral comparison ratios (“SCRs”) of the new radiation measurement and the background radiation measurement for a particular location can be calculated to perform a spectral comparison. SCRs are well-known in the art and are described in Pfund, D. M. et al., “Examination of Count-Starved Gamma Spectra Using the Method of Spectral Comparison Ratios,” IEEE Transactions on Nuclear Science, vol. 54, pp. 1232-1238, August 2007 and Jarman, K. D. et al., “A comparison of simple algorithms for gamma-ray spectrometers in radioactive source search applications,” Applied Radiation and Isotopes, vol. 66, pp. 362-371, March 2008, for example. Similar as described above, for each of the new radiation measurement and the background radiation measurement, the number of counts having respective energy levels within each of the energy bins are summed. For example, binning the number of counts in n energy bins creates a vector of new radiation measurement counts c=[c₁, c₂, . . . cₙ] and a vector of background radiation measurement counts b=[b₁, b₂, . . . bₙ]. One of the energy bins can be chosen as a reference bin (e.g., bin 1 in the example below). It should be understood, however, that the choice of the reference bin is unimportant and can be any one of the n energy bins, as the anomaly statistic has been shown to be invariant to the choice of bin. Runkle, R. et al., “Lynx: An unattended sensor system for detection of gamma-ray and neutron emissions from special nuclear materials,” Nuclear Instruments and Methods in Physics Research A, vol. 598, pp. 815-825, 2009. The SCRs can then be computed as shown by Eqn. (1).

$${s}_{i} = {c}_{1} - \frac{{b}_{1}}{{b}_{i}} {c}_{i} , \qquad ( 1 )$$

where i>1. In Eqn. (1), c₁ and b₁ are the numbers of counts in the reference energy bin. Eqn. (1) is mathematically equivalent to multiplying the vector c by a spectral shape matrix S as shown by Eqns. (2) and Eqn. (3).

$$S = ( \begin{matrix}1 & - \frac{{b}_{1}}{{b}_{2}} & 0 & … & 0 \\ 1 & 0 & - \frac{{b}_{1}}{{b}_{3}} & … & 0 \\ ⋮ & & & & \\ 1 & 0 & 0 & … & - \frac{{b}_{1}}{{b}_{n}}\end{matrix} ) \qquad ( 2 )$$

s=S·c (3)

There are (n−1) linearly independent SCRs, since one energy bin is a reference energy bin. The SCR process compares c₁ against projections based on the ratio between energy bins in the background radiation measurement and the counts in the ith energy bin. The deviations of the projections are given in the SCR vector, s. Since the SCR vector, s, is computed using ratios between energy bins, the SCR vector, s, is insensitive to global changes in count rate unless the changes in count rate alter the spectral shape. Accordingly, SCRs allow for comparisons of spectra made with unequal observation times. For example, the new radiation measurement can include data collected during a relatively short time interval (e.g., 30 seconds), and the background radiation measurement, which can be calculated by aggregating a plurality of radiation measurement records collected over a wide area that has been aggregated into spatial cells, can include data collected during a relatively long time interval (e.g., minutes, hours, etc.). Thus, the SCRs facilitate the comparison of the new radiation measurement and the background radiation measurement, which may have unequal observation times.

It is possible to determine whether the new radiation measurement is anomalous based on the spectral comparison. For example, if a change between the respective spectral contents of the new radiation measurement and the background radiation measurement is consistent with the expected variation in the background radiation measurement (e.g., the variation in the background radiation measurement as measured or calculated as described herein), then the new radiation measurement is not anomalous. However, if a change between the respective spectral contents of the new radiation measurement and the background radiation measurement is not consistent with the expected variation in the background radiation measurement (e.g., the variation in the background radiation measurement as measured or calculated as described herein), then the new radiation measurement is anomalous. As described above, when performing a spectral comparison, a vector of counts c=[c₁, c₂, . . . cₙ] and a vector of counts b=[b₁, b₂, . . . bₙ] are created for the new and background radiation measurements, respectively, by binning the number of counts in n energy bins. In addition, the expected variation in the background radiation measurement can include an expected variation for each of the n energy bins. Optionally, a vector difference between the vector of counts c=[c₁, c₂, . . . cₙ] (i.e., the vector of new radiation measurement counts) and the vector of counts b=[b₁, b₂, . . . bₙ] (i.e., the vector of background radiation measurement counts), taking into account the expected variation thereof, can be calculated in order to express the change between the respective spectral contents of the new and background radiation measurements as a single value. Optionally, the vector difference can be a Mahalanobis distance (described below). Although the Mahalanobis distance is provided as an example, this disclosure contemplates that other known techniques such as model fitting and residual error determination, for example, can be used to calculate the vector distance.

When using a vector distance, the change between the respective spectral contents of the new radiation measurement and the background radiation measurement is consistent with the expected variation under the condition that the vector difference is less than or equal to a predetermined threshold value. On the other hand, the change between the respective spectral contents of the new radiation measurement and the background radiation measurement is not consistent with the expected variation under the condition that the vector difference is greater than a predetermined threshold value. The predetermined threshold value can be derived from the expected variation in the background radiation measurement (e.g., the measured or calculated variation in the background radiation measurement as described herein, as opposed an assumed variation in the background radiation level). For example, the predetermined threshold can be a multiplicative number of the expected variation (e.g., 1-sigma, 2-sigma, etc., where sigma is the expected variation). In contrast, according to conventional techniques, variation in background radiation is not actually measured. Instead, the variation in background radiation is assumed to follow the Poisson distribution (i.e., background radiation and error equals N±\sqrt{N}, where N is the observed number of counts). Thus, variation (and therefore alarm thresholds) according to conventional techniques are prescribed based on the assumption that the variation follows the Poisson distribution. It should be understood that the predetermined threshold value can be selected by the system administrator to tune the desired sensitivity of anomaly detection, for example, based on a desired false alarm rate (described below). For example, the alarm thresholds can be set to alert a user to radiation measurements with a 1 in Y (e.g., 1 in 100, 1 in 1000, etc.) probability of occurring naturally (i.e., due to naturally occurring variation in background radiation). In addition, the vector difference can be greater than the predetermined threshold value due to an increase or decrease in radioactivity within the geographic region. For example, radioactivity within the geographic region can increase or decrease, and sometime unexpectedly, due to insertion or removal of a radioactive source. Alternatively, radioactivity within the geographic region may change due to the replacement of one radioactive source with another, which may maintain a constant count rate in a given area but alter the spectral content such that the vector difference also changes. Alternatively or additionally, radioactivity within the geographic region can increase or decrease due to other events such as changes in radioactivity from naturally occurring radon or changes due to fallout from a nuclear event. In any of these cases, it is desirable to detect such changes in radioactivity within the geographic region as anomalous (e.g., inconsistent with the expected variation of the background radiation measurement). Optionally, in response to determining that the new radiation measurement is anomalous, an alarm can be generated. For example, the alarm can be generated by the computing device that compares the new radiation measurement and the background radiation measurement (e.g., the remote computing device 112 in FIG. 1). The alarm can optionally be transmitted, for example, to the detection device (e.g., the detection system 100 in FIG. 1) that collected the new radiation measurement, for example, to alert the user. Alternatively or additionally, the alarm can optionally be transmitted to one or more remote systems such as emergency management and/or civil crisis centers for the geographic region. This disclosure contemplates that the alarm can be configured to trigger at least one of an audio, visual or tactile alarm.

In order to accurately detect anomalous radiation measurements, it is important to understand the expected variation in the natural background radiation. Thus, an example technique for measuring the expected variation in the background radiation level for a particular location within a geographic region is now provided. Similar to above, the particular location within the geographic region can be point “B” in FIG. 3, which is located in cell 302n. In other words, the geographic region is divided into a plurality of cells, for example, as shown in FIG. 3. Also similar to above, the spectrum is divided into a plurality of energy bins (or spectral bins), and the number of counts having respective energy levels associated with each of the energy bins are aggregated, for example, to create a vector of counts c=[c₁, c₂, . . . cₙ] and a vector of counts b=[b₁, b₂, . . . bₙ] for the new and background radiation measurements, respectively. The vector of counts b=[b₁, b₂, . . . bₙ] for the background radiation measurement can be obtained using the spatial-spectral-temporal database as described above by summing one or more of the radiation measurement records contained therein. In particular, to measure the expected variation in the background radiation measurement for the particular location (e.g., point “B” in FIG. 3) using the spatial-spectral-temporal database, it is possible to query the spatial-spectral-temporal database for the radiation measurement records associated with each of a plurality of time intervals. In other words, the duration over which radiation measurements for the geographic region have been collected can be divided into discrete time intervals. For example, the time intervals can optionally be 30-second intervals. Alternatively, this disclosure contemplates that the discrete time intervals can be more or less than 30 seconds in length. Then, for each discrete time interval, the number of counts associated with the radiation measurement records contained in the spatial-spectral-temporal database having respective energy levels associated with the energy bins can be summed. This operation is similar to the binning of counts into n energy bins as described above, but the operation is performed for each of the discrete time intervals. Optionally, the radiation measurement records can be all of the radiation measurement records contained in the spatial-spectral-temporal database. Alternatively, the radiation measurement records can be only the radiation measurement records associated with a sub-region of the geographic region (e.g., only those radiation measurement records associated with cell 302n in FIG. 3) contained in the spatial-spectral-temporal database. Then, as described in detail below, correlations between the number of counts having the respective energy level associated with the energy bins over the discrete time intervals can be calculated, and a covariance between the number of counts having the respective energy level associated with the energy bins over the discrete time intervals can be estimated based on the correlations.

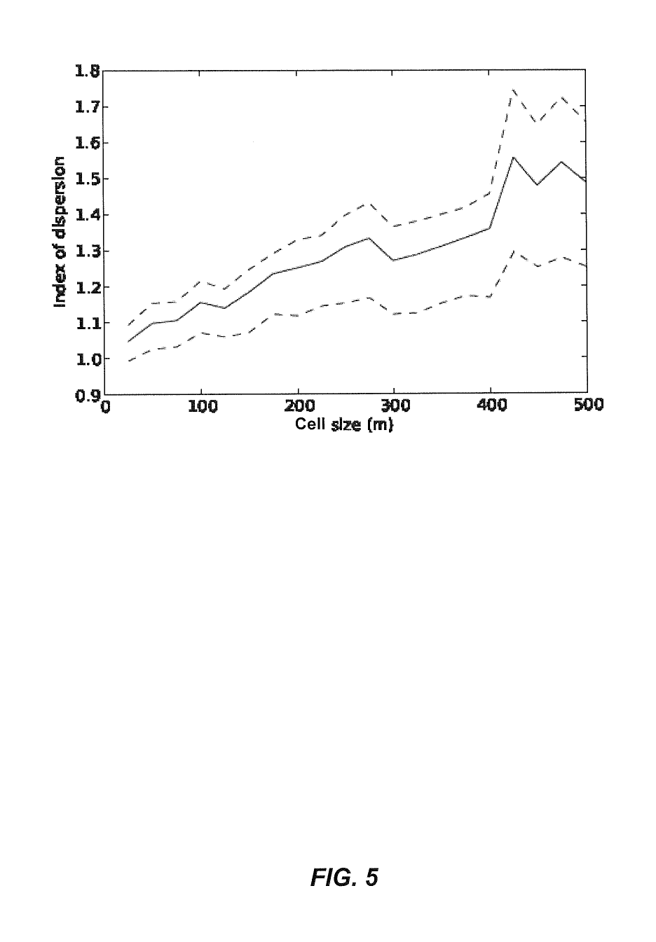

It is assumed that counts in each energy bin follow an overdispersed Poisson distribution. As counts are aggregated across geographic cells having larger dimensions, the counts become overdispersed. This is shown in FIG. 5, which is a graph illustrating the mean, minimum and maximum index of dispersion of counts in each energy bin for all geographic cells of a geographic region at specified cell sizes. Consequently, it is possible to approximate var(cᵢ)=Vcᵢ, where V is the average variance-to-mean ratio of count rates (V=1 for perfectly Poisson-distributed counts). V can be selected empirically by calculating the ratio for the area of interest. The relationship between the variance of random variables can be express by Eqn. (4).

var(aX+bY)=a² var(X)+b² var(Y)+2ab cov(X,Y) (4)

Hence, using Eqn. (1), var(sᵢ) can be estimated as shown by Eqn. (5).

$$var ( {s}_{i} ) = {Vc}_{1} + {( \frac{{b}_{1}}{{b}_{i}} )}^{2} {Vc}_{i} - 2 \frac{{b}_{1 }}{{b}_{i}} cov ( {c}_{1} , {c}_{i } ) \qquad ( 5 )$$

In Eqn. (5), b is treated as an exact value rather than having its variance propagated. This is a simplification because Eqn. (1) is nonlinear in b and an exact variance estimate could not be derived. Consequently, var(sᵢ) may be underestimated, but as described below, anomaly detection can be performed with sufficient accuracy despite the impact of this underestimation.

The covariance cov(c₁, cᵢ) can be estimated from all previous background radiation measurements collected in a particular cell (e.g., cell 302n in FIG. 3), such that cov(c₁, cᵢ)∝ cov(b₁, bᵢ) However, spatial mapping may be impractical if it required numerous, repeated radiation measurement to be collected in the particular cell before detecting anomalies. As described in Morrison, D. F., Multivariate Statistical Methods. Duxbury, 4th ed., 2005, the relationship between the covariance cov(bᵢ, bⱼ) and the correlation corr(bᵢ, bⱼ) is shown by Eqn. (6).

cov(bᵢ,bⱼ)=corr(bᵢ,bⱼ)\sqrt{var(bᵢ)var(bⱼ)} (6)

To replace cov(c₁, cᵢ), rescaling may be needed. For example, the vector of background radiation measurement counts b may have resulted from an observation (or radiation measurement) of a different duration (or observation time) than the vector of new radiation measurement counts c. Consequently, it is possible to replace covariance with a correlation as shown in Eqn. (7).

$$var ( {s}_{i} ) = V ( {c}_{1} + {( \frac{{b}_{1}}{{b}_{i}} )}^{2} {c}_{i} - 2 \frac{{b}_{1}}{{b}_{i}} {( \frac{{T}_{c}}{{T}_{b}} )}^{2} corr ( {b}_{1} , {b}_{i} ) \sqrt{{b}_{1} {b}_{i}} ) \qquad ( 7 )$$

where Tc is the time taken to observe c (e.g., the amount of time for which the new radiation measurement is collected) and T_{b} the time taken to observe b (e.g., the amount of time for which the background radiation measurement is collected). This is obtained by replacing var(bᵢ) with

$$var ( {b}_{i} \frac{Tc}{Tb} ) .$$

and likewise for var(bⱼ), rescaling the observation to match the new observation time.

To compute corr(b₁, bᵢ), the background radiation measurements previously collected within the cell in which the particular location is located (e.g., cell 302n) are not the only background radiation measurements used, as there may not enough data to make this possible. Instead, corr(b₁, bᵢ) can be calculated using the background radiation measurements previously collected for all of the cells in the geographic region (e.g., all of cells 302 in FIG. 3) by summing together observations into thirty-second intervals. As described above, the radiation measurement records previously collected for the geographic region are stored the spatial-spectral-temporal database. Alternatively, and particularly when there is a large amount of background radiation measurement records stored in the spatial-spectral-temporal database, corr(b₁, bᵢ) can be computed using only the background radiation measurements previously collected within the cell in which the particular location is located (e.g., cell 302n). As described above, the radiation measurement records previously collected for the geographic region are stored in the spatial-spectral-temporal database, and the radiation measurement records associated with the particular cell (e.g., cell 302n) can be returned by querying the spatial-spectral-temporal database. The correlation between the energy bins for these summed background radiation measurements can then be computed.

The covariance matrix Σij between energy bins in the SCR vector, s, can be constructed as shown by Eqn. (8).

Σij=corr( [symbol] ᵢ, [symbol] ⱼ)\sqrt{var( [symbol] ᵢ)var( [symbol] ⱼ)} (8)

where corr(sᵢ, sⱼ) is estimated by summing all the background radiation measurements previously collected for all of the cells in the geographic region (e.g., all of cells 302 in FIG. 3) in the same way as for corr(b₁, bᵢ), and then comparing each observation to the global mean spectrum to produce the SCR vector, s. In other words, the radiation measurement records previously collected for the geographic region can be queried from the spatial-spectral-temporal database as described above and then can be used to calculate the covariance matrix Σij,

It should be understood that the direct calculation of the covariance matrix Σij from the data (e.g., the radiation measurement records contained in the spatial-spectral-temporal database) would be impossible with too few background radiation measurements collected in the geographic region. In particular, in order to produce a well-conditioned and invertible covariance matrix, many more observations (e.g., radiation measurements) than variables are required. This would require numerous, repeated radiation surveys to be conducted in the geographic region before any anomalies can be detected, which makes the known SCR algorithms impractical. Further, any similar techniques using covariance matrices require each cell of the geographic region to contain observations of equal length and/or require new covariance matrices to be computed for each cell of the geographic region. However, by using assumptions about the distribution of the data, it is possible to avoid requiring direct calculation of the covariance matrix Σij from the data, as required by known SCR algorithms. Therefore, the technique for estimating the expected variation in the background radiation measurement that relates correlations to covariance in the background radiation measurements avoids the direct calculation of the covariance matrix Σij from the data. Further, the correlation matrices described above can be computed and reused for anomaly detection for all cells of the geographic region. Alternatively, in very large geographic regions where radiation spectra may vary greatly, the correlation matrices can be estimated separately for smaller areas (e.g., sub-regions) within the geographic region.

As described above, a vector difference between the vector of counts c=[c₁, c₂, . . . cₙ] (i.e., the vector of new radiation measurement counts) and the vector of counts b=[b₁, b₂, . . . bₙ] (i.e., the vector of background radiation measurement counts), taking into account the expected variation thereof, can be calculated in order to express the change between the respective spectral contents of the new and background radiation measurements. Additionally, the vector difference can be used to determine whether the new radiation measurement is anomalous. An anomaly detection algorithm that uses the SCR vector, s, is described in Pfund, D. M. et al., “Examination of Count-Starved Gamma Spectra Using the Method of Spectral Comparison Ratios,” IEEE Transactions on Nuclear Science, vol. 54, pp. 1232-1238, August 2007. In these applications, a set of many independent background radiation measurements are collected, and an SCR vector, s, is calculated for each background radiation measurement. After computing a covariance matrix Σ for the resulting set of SCR vectors, an SCR vector, s, is calculated for the new radiation measurement, which is then compared to the background radiation level through the mathematical construct of the Mahalanobis distance as shown by Eqn. (9).

D²=s^{T}Σ⁻¹s (9)

The Mahalanobis distance measures the difference between a multivariate observation and the typical mean, normalizing by the typical variance expressed in the covariance matrix. Morrison, D. F., Multivariate Statistical Methods. Duxbury, 4th ed., 2005. This implies that spectral shape changes consistent with already-observed natural background variations will cause only small increases in D², while changes very different from the already-observed natural background variations will produce large increases in D².

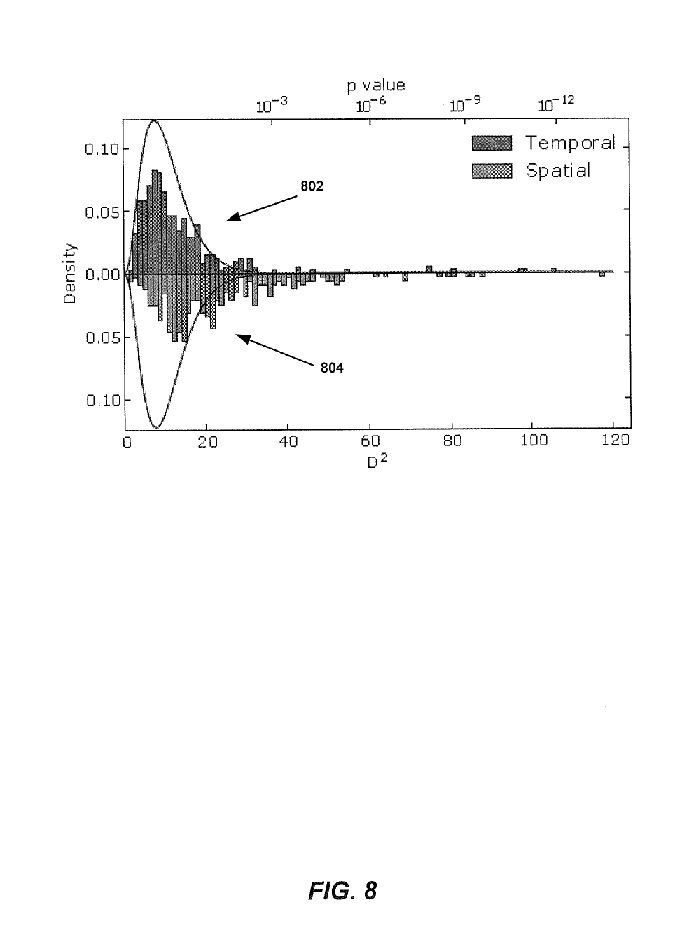

If the estimated covariance matrix Σ is accurate and the background radiation source is unchanging, the Mahalanobis distance D² should be ×²-distributed with (n−1) degrees of freedom. In practice there may be slight background fluctuations from various natural processes, and the distribution may depart slightly from theoretical predictions. Pfund, D. M. et al., “Low Count Anomaly Detection at Large Standoff Distances,” IEEE Transactions on Nuclear Science, vol. 57, no. 1, pp. 309-316, 2010. This is also shown by FIG. 8, which is a graph illustrating the distribution of the SCR anomaly statistic, D², in 250-meter geographic cells for a university research campus in an example data set, with an χ² distribution (with 7 degrees of freedom) overlaid. Due to Eqn. (7), as T_{c} increases var(sᵢ) decreases, which renders the anomaly detection techniques described herein more sensitive with longer observation times.

By setting a desired alarm threshold D_{A} based on typical natural spectral variations, it is possible to search for unnaturally large spectral anomalies, which may indicate source changes. Further, as described above, in order to monitor a wide area (e.g., the geographic region), previously collected radiation measurements can be stored in the spatial-spectral-temporal database and can be aggregated for sub-regions (e.g., the cells of the geographic region). Thus, the cumulative spectrum in each cell can be compared to previous observations. Using the techniques described herein, each cell may contain different numbers of radiation measurements, and an individual cell may have observations at different times and locations from day to day.

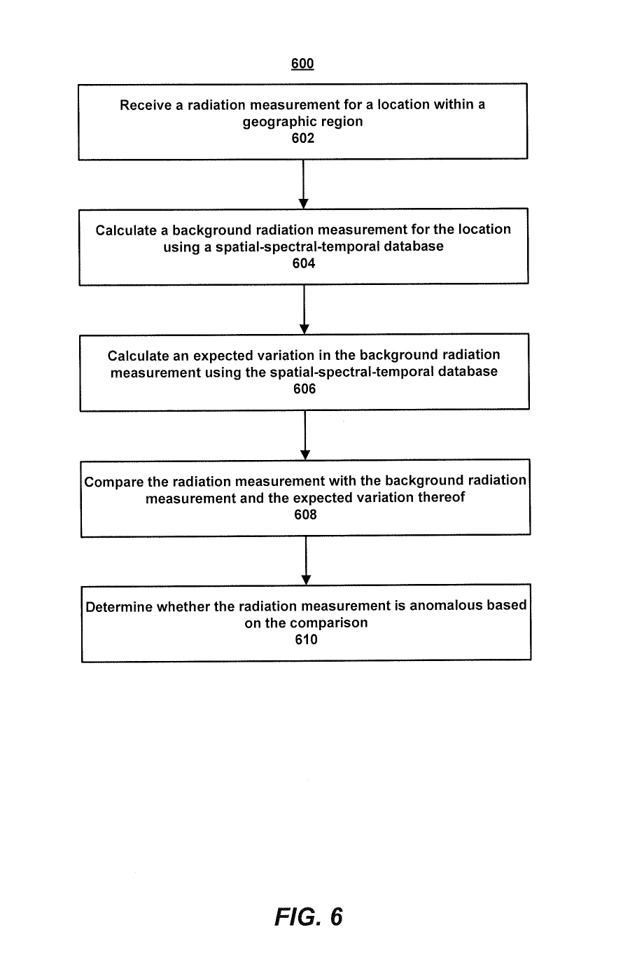

Referring now to FIG. 6, a flow diagram illustrating example operations 600 for identifying anomalous radiation measurements acquired in a geographic region is shown. It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

At 602, a radiation measurement for a location within the geographic region is received. As described above, the radiation measurement is associated with location and time data. For example, the radiation measurement can be collected with the radiation detector 102 of FIG. 1, and the radiation measurement can optionally be transmitted from the local computing device 108 of the detection system 100 over the network 110 and can be received by the remote computing device 112. The location can optionally be point “B” in the geographic region 300 of FIG. 3, which is located in cell 302n, for example. At 604, a background radiation measurement for the location (e.g., point “B” in FIG. 3) can be calculated using a spatial-spectral-temporal database. The spatial-spectral-temporal database can include a plurality of previously-collected radiation measurement records for the geographic region (e.g., the region 300 in FIG. 3), where each radiation measurement record includes a respective radiation measurement that is associated with location and time data. The background radiation measurement can be calculated by any of the techniques described above including, but not limited to, based only on the radiation measurement records associated with the cell (e.g., cell 302n) in which the location (e.g., point “B” in FIG. 3) is located. As described above, the spatial-spectral-database can optionally be maintained by the remote computing device 112 and can be queried based on location (e.g., geographic coordinates) and/or time (e.g., TOD) data.

At 606, an expected variation in the background radiation measurement for the location (e.g., point “B” in FIG. 3) can be calculated using the spatial-spectral-temporal database. The expected variation can be measured by any of the techniques described above including, but not limited to, by calculating correlations between the number of counts for the background radiation measurement having respective energy levels associated with the energy bins over discrete time intervals and estimating a covariance based on the calculated correlations. At 608, the radiation measurement can be compared with the background radiation measurement and the expected variation, for example, by calculating a vector difference. Then, at 610, a determination is made as to whether the radiation measurement is anomalous based on the comparison, for example, by comparing the vector difference to a predetermined alarm threshold.

### Examples

A sample dataset was collected over a period of approximately 50 days at the University of Texas's J. J. Pickle Research Campus (“Pickle Research Campus), which is also referred to as “the university research campus” herein. In other words, the Pickle Research Campus is the example “geographic region.” To survey the campus, a radiation detection system (e.g., the detection system 100 in FIG. 1) was placed in a golf cart and driven on most work days on irregular routes. Total observation time amounted to twenty hours in forty-eight observation runs containing a total of more than 37,000 individual two-second observations.

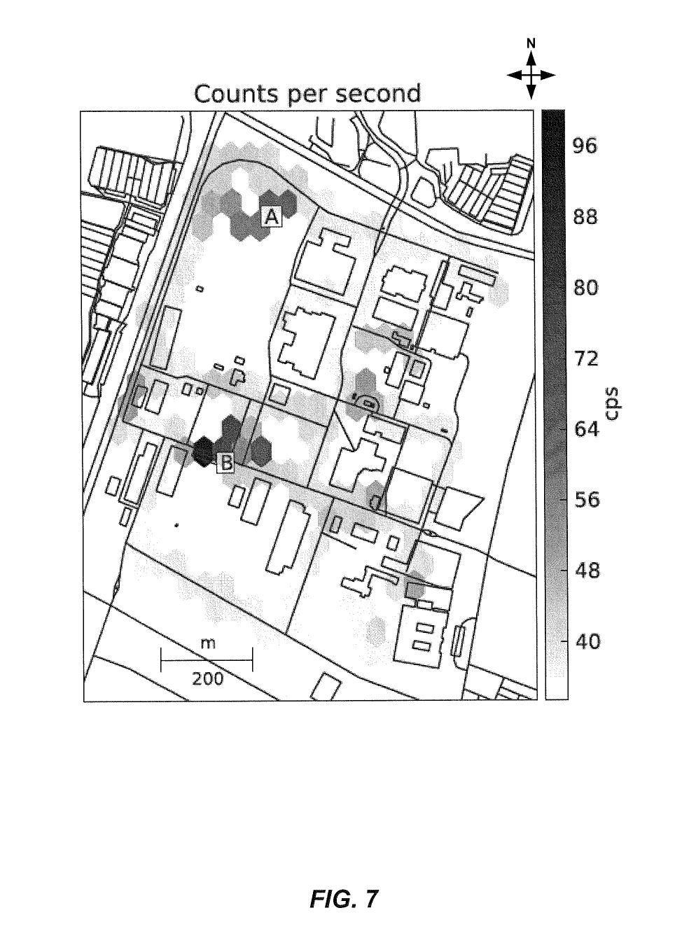

The natural gamma background varies spatially and temporally due to many natural factors. The surveys revealed a spatially varying natural background across Pickle Research Campus. For example, referring to FIG. 7, a map of the Pickle Research Campus with gamma counts per second averaged over a one-month period overlaid is shown. The areas of elevated background include a radioactive material storage facility at a northwest corner (at point “A”) and a cluster of large brick buildings near the center of the campus (at point “B”).

Poisson Distribution Assumption

The approach of the techniques described herein relies on the underlying Poisson distribution of radiation data. Thus, to test the assumptions, Poisson dispersion tests were performed on the dataset as a function of spatial scales. The Poisson dispersion test determines whether a given set of observations could plausibly have been drawn from the same Poisson distribution. Rao, C. R. and Chakravarti, I. M., “Some small sample tests of significance for a Poisson distribution,” Biometrics, vol. 12, pp. 264-282, September 1956. The test computes a dispersion parameter P, defined by Eqn. (10).

$$P = \frac{1}{\overline{x}} {\sum }_{i = 1}^{N} {( {x}_{i} - \overline{x} )}^{2} \qquad ( 10 )$$

where x̅ is the mean of all observations xᵢ and N the total number of observations. This parameter is χ²-distributed with (N−1) degrees of freedom. Using this distribution, a p value can be computed for P, indicating the probability that the observed distribution of values would arise from a Poisson-distributed random variable. For example, dividing the dataset into 125-meter grid cells (e.g., the dimensions of the cells of the geographic region), it is found that on average, p=0.33. Accordingly, the data is Poisson distributed. Additionally, when the dataset is divided into 250-meter grid cells, p=0.17.

To quantify this, the index of dispersion was computed for all cells of the geographic region at various cell sizes. The index of dispersion V is a measure of the variance of a distribution, compared to its mean, which is described by Eqn. (11).

$$V = \frac{{σ}^{2}}{μ} \qquad ( 11 )$$

where μ is the distribution's mean and σ² is the distribution's variance. The variance of a Poisson distribution equals its mean, so the index of dispersion is expected to be one. FIG. 5, which is a graph illustrating the mean, minimum and maximum index of dispersion of counts in each energy bin for all geographic cells of a geographic region at specified cell sizes, shows mean indices of dispersion for various grid cell sizes, demonstrating that smaller cells tend to have count rate distributions closer to the Poisson distribution, as expected. To account for this, the dispersion parameter V in Eqn. (7) can be adjusted to match the mean index of dispersion for cells at a chosen spatial scale. It should be understood, however, that the optimal dimensions for the cells may be dependent on the nature of the geographic region being mapped. For example, geographic regions with greater spectral variation on short spatial distances may be mapped with smaller spatial cells.

Comparing Spatial and Temporal Variation

The dataset collected for the Pickle Research Campus revealed not only spatial but temporal variation in background. To compare the temporal variation to the spatial variation, the observation area was divided into grid cells 250 meters on each side, and each day's set of observations was compared to two or more previous days using the anomaly detection techniques described above (e.g., the SCRAM algorithm). Referring now to FIG. 8, a graph illustrating the distribution of the SCR anomaly statistic, D², in 250-meter geographic cells for the Pickle Research Campus in an example data set, with an χ² distribution (with 7 degrees of freedom) overlaid is shown. The upper histogram 802 is the result of comparing each geographic cell to the same geographic cell on the previous day and illustrates temporal variation. The lower histogram 804 is the result of comparing each geographic cell to a fixed reference geographic cell and illustrates spatial variation. As shown in FIG. 8, the lower histogram 804 is shifted to the right as compared to the upper histogram 802.

As shown in FIG. 8, the spatial distribution is clearly shifted to the right, indicating that there is more spatial variance than temporal variance. In other words, the knowledge of the prior background at a particular location may be more useful than the knowledge of observations collected thirty seconds ago at a different location, allowing more sensitive detection. Accordingly, it may be desirable to compare spectral observations to previous spectral observations made in the same place (e.g., at or near the same location), rather than to compare spectral observations to previous spectral observations made at other locations. The background spectra tend to vary much more spatially than they do temporally. Therefore, using the anomaly detection techniques described herein, alarm thresholds can be set lower, giving higher sensitivity without increased false alarm rates.

Referring again to FIG. 8, the presence of p<10⁻³ anomalies is not unusual. The p-values are computed under the χ² distribution, which the data do not follow perfectly. There are, of course, some true variations in natural background in the data, and the distribution of counts may be more or less overdispersed in different spatial cells. As described above, estimates of var(sᵢ) are systematically low, making some observations appear more anomalous than they should. Also, some spectral comparisons were made with little data, for example, because of irregular routes, a spatial cell may only contain a few seconds of data, giving a lesser-quality estimate of the spectrum in that cell. Despite of these limitations, the anomaly detection techniques described herein provide for practical for anomaly detection, as demonstrated below.

Detection Performance

To demonstrate the expected performance of the anomaly detection techniques described herein, several simulations were performed. Simulations used real observed spectra from a 0.844 μCi cesium-137 check source. The simulation code was calibrated by placing the source at known distances from a scintillator detector (e.g., the radiation detector 102 of FIG. 1), and accounted for geometric attenuation of count rates, as well as the exponential attenuation due to gamma absorption in air.

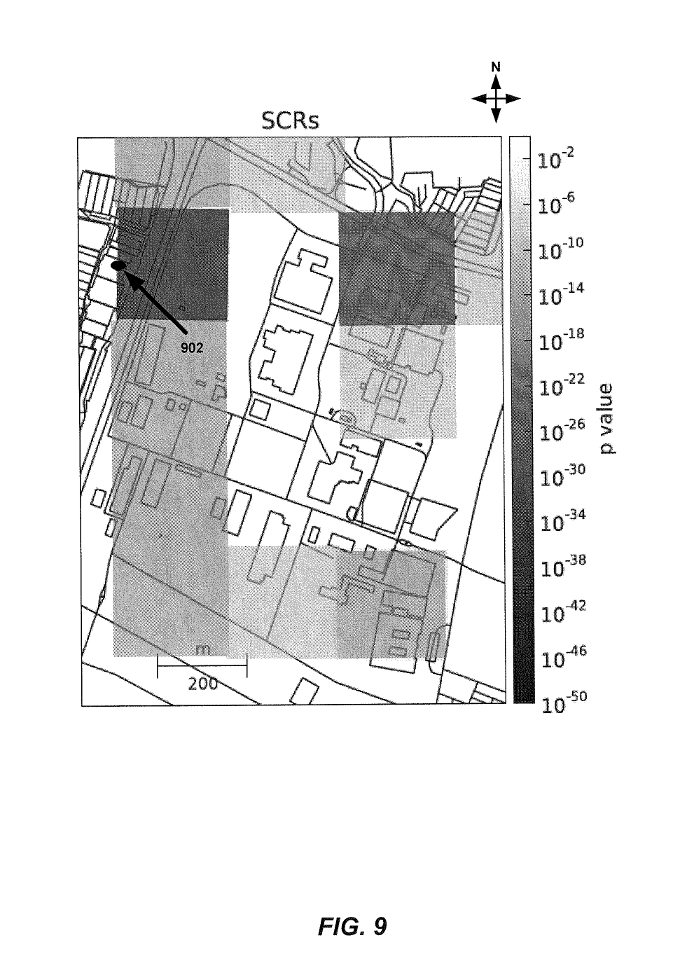

Referring now to FIG. 9, a heatmap of the SCR values for the Pickle Research Campus comparing one day to the previous days, with ρ values computed based on the χ² distribution of D² is shown. The first simulation, which is illustrated by FIG. 9, injected a simulated 275 mCi cesium-137 source on the west side of Pickle Research Campus, 100 meters from the detector's typical path at point 902. The radiation detector traveled along an adjacent road, never closer than 100 m. The detector, driving past at roughly 10 miles per hour, easily detected the source with D²=156, which is a far larger anomaly than any natural variation recorded in FIG. 8. This demonstrates the ability of a small moving detector to detect sources at distance.

Next, a second simulation was performed to calculate the minimum detectable radioactive source size at a variety of distances. The same straight stretch of road (e.g., the adjacent road in FIG. 9) on the northwest corner of the Pickle Research Campus was selected, and the injection of a cesium-137 source at various distances from the adjacent road was simulated into the collected background data.

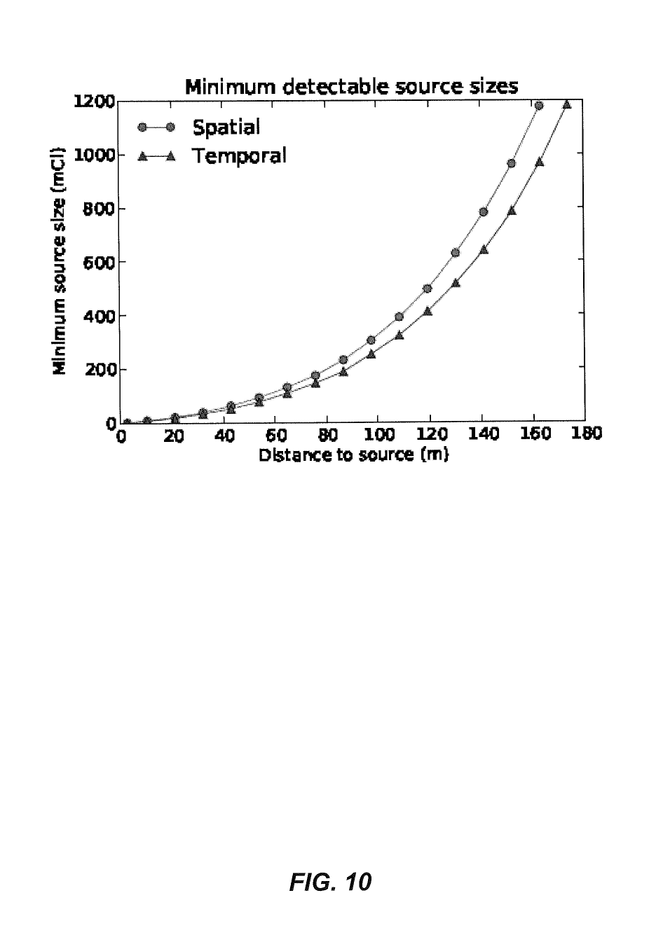

To choose an alarm threshold, the anomaly statistics distribution data shown in FIG. 8 was used, selecting a threshold which only 1% of the example dataset exceeds. This corresponds to a 1% false alarm rate. The Domestic Nuclear Detection Office has published testing methodologies, including require less than one false alarm per hour for 60-second integrations, which amounts to a 1.7% false alarm rate. Thus, the 1% false alarm rate is more strict, but not necessarily directly comparable because the spectral comparisons used in the anomaly detection techniques described herein are made per spatial cell, rather than per 60-second integration. Although a 1% false alarm rate was used in the example, it should be understood that the false alarm rate can be chosen to be more or less than 1% based on the requirements of the user. For temporal comparisons of spectra, the alarm threshold is D²_{A}=83, while for purely spatial comparisons the result is D²_{A}=113. The minimum source size required to achieve a statistical power of 0.8 (e.g., detection of a true positive at least 80% of the time) for both thresholds was computed. The results are shown in FIG. 10. These results show that taking advantage of the exact prior background spectrum at each location leads to approximately 20% better detection performance over the use of spectra from a single fixed reference point.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for identifying anomalous radiation measurements acquired in a geographic region, comprising:
receiving a radiation measurement for a location within the geographic region, the radiation measurement being associated with location and time data;
calculating a background radiation measurement for the location using a spatial-spectral-temporal database that includes a plurality of radiation measurement records for the geographic region, each of the radiation measurement records including a respective radiation measurement that is associated with location and time data;
calculating an expected variation in the background radiation measurement using the radiation measurement records contained in the spatial-spectral-temporal database;
comparing the radiation measurement with the background radiation measurement and the expected variation in the background measurement; and
determining whether the radiation measurement is anomalous based on the comparison.

2. The method of claim 1, further comprising:
dividing the geographic region into a plurality of cells; and
identifying a particular cell containing the location, wherein calculating the background radiation measurement comprises collecting respective radiation measurements for one or more of the radiation measurement records contained in the spatial-spectral-temporal database that are associated with the particular cell.

3. (canceled)

4. The method of claim 2, wherein comparing the radiation measurement with the background radiation measurement and the expected variation in the background measurement further comprises performing a spectral comparison between spectral content of the radiation measurement and spectral content of the background radiation measurement.

5. The method of claim 4, wherein performing a spectral comparison between spectral content of the radiation measurement and spectral content of the background radiation measurement further comprises:
dividing an energy spectrum into a plurality of energy bins;
for each of the radiation measurement and the background radiation measurement, summing a number of counts having a respective energy level associated with each of the energy bins; and
comparing the number of counts having the respective energy level associated with each of the energy bins for the radiation measurement and the background radiation measurement, respectively.

6. The method of claim 5, wherein the energy bins are distributed evenly across the energy spectrum.

7. The method of claim 5, wherein the energy bins are distributed across the energy spectrum to cover one or more targeted spectral regions or one or more targeted isotopes.

8. The method of claim 4, wherein determining whether the radiation measurement is anomalous based on the comparison further comprises determining whether a change between the spectral content of the radiation measurement and the spectral content of the background radiation measurement is consistent with the expected variation in the background radiation measurement.

9. The method of claim 1, wherein calculating an expected variation in the background radiation measurement using the radiation measurement records contained in the spatial-spectral-temporal database further comprises:
dividing an energy spectrum into a plurality of energy bins;
for each of a plurality of discrete time intervals, summing a number of counts associated with one or more of the radiation measurement records contained in the spatial-spectral-temporal database having a respective energy level associated with at least one of the energy bins;
calculating correlations between the number of counts having the respective energy level associated with the at least one of the energy bins over the discrete time intervals; and
estimating a covariance between the number of counts having the respective energy level associated with the at least one of the energy bins over the discrete time intervals based on the correlations.

10. The method of claim 9, wherein the one or more of the radiation measurement records comprise all of the radiation measurement records contained in the spatial-spectral-temporal database.

11. The method of claim 9, wherein the one or more of the radiation measurement records are associated with locations within a sub-region of the geographic region.

12. The method of claim 1, wherein determining whether the change between the spectral contents of the radiation measurement and the background radiation measurement is consistent with the expected variation in the background radiation measurement further comprises calculating a vector difference.

13. The method of claim 12, wherein the change between the spectral contents of the radiation measurement and the background radiation measurement is consistent with the expected variation in the background radiation measurement under the condition that the vector difference is less than or equal to a predetermined threshold value.

14. The method of claim 12, wherein the change between the spectral contents of the radiation measurement and the background radiation measurement is not consistent with the expected variation in the background radiation measurement under the condition that the vector difference is greater than a predetermined threshold value.

15. The method of claim 13, wherein the predetermined threshold is derived from the expected variation in the background radiation measurement.

16. The method of claim 14, wherein the vector difference is greater than the predetermined threshold value due to an increase in radioactivity within the geographic region.

17. The method of claim 14, wherein the vector difference is greater than the predetermined threshold value due to a decrease in radioactivity within the geographic region.

18. The method of claim 1, further comprising creating and maintaining the spatial-spectral-temporal database by performing multi-pass radiation measurement surveys within the geographic region.

19. The method of claim 1, further comprising generating an alarm in response to determining that the radiation measurement for the location is anomalous.

20. A system for identifying anomalous radiation measurements acquired in a geographic region, comprising:
a detection system including:
a radiation detector configured for acquiring radiation measurements,
a location detection device configured for acquiring location data associated with the radiation measurements,
a timing device configured for acquiring time data associated with the radiation measurements; and
a computing device including a processor and memory operably coupled to the processor, the memory having computer-executable instructions stored thereon that, when executed by the processor, cause the computing device to:
receive a radiation measurement for a location within the geographic region from the detection system, the radiation measurement being associated with location and time data;
calculate a background radiation measurement for the location using a spatial-spectral-temporal database that includes a plurality of radiation measurement records for the geographic region, each of the radiation measurement records including a respective radiation measurement that is associated with location and time data;
calculate an expected variation in the background radiation measurement using the radiation measurement records contained in the spatial-spectral-temporal database;
compare the radiation measurement with the background radiation measurement and the expected variation in the background measurement; and
determine whether the radiation measurement is anomalous based on the comparison.

21. The system of claim 20, wherein the memory has further computer-executable instructions stored thereon that, when executed by the processor, cause the computing device to:
divide the geographic region into a plurality of cells; and
identify a particular cell containing the location, wherein calculating the background radiation measurement comprises collecting respective radiation measurements for one or more of the radiation measurement records contained in the spatial-spectral-temporal database that are associated with the particular cell.

22. (canceled)

23. The system of claim 21, wherein comparing the radiation measurement with the background radiation measurement and the expected variation in the background measurement further comprises performing a spectral comparison between spectral content of the radiation measurement and spectral content of the background radiation measurement.

24. The system of claim 23, wherein performing a spectral comparison between spectral content of the radiation measurement and spectral content of the background radiation measurement further comprises:
dividing an energy spectrum into a plurality of energy bins;
for each of the radiation measurement and the background radiation measurement, summing a number of counts having a respective energy level associated with each of the energy bins; and
comparing the number of counts having the respective energy level associated with each of the energy bins for the radiation measurement and the background radiation measurement, respectively.

25. The system of claim 24, wherein the energy bins are distributed evenly across the energy spectrum.

26. The system of claim 24, wherein the energy bins are distributed across the energy spectrum to cover one or more targeted spectral regions or one or more targeted isotopes.

27. The system of claim 23, wherein determining whether the radiation measurement is anomalous based on the comparison further comprises determining whether a change between the spectral content of the radiation measurement and the spectral content of the background radiation measurement is consistent with the expected variation in the background radiation measurement.

28. The system of claim 20, wherein calculating an expected variation in the background radiation measurement using the radiation measurement records contained in the spatial-spectral-temporal database further comprises:
dividing an energy spectrum into a plurality of energy bins;
for each of a plurality of discrete time intervals, summing a number of counts associated with one or more of the radiation measurement records contained in the spatial-spectral-temporal database having a respective energy level associated with at least one of the energy bins;
calculating correlations between the number of counts having the respective energy level associated with the at least one of the energy bins over the discrete time intervals; and
estimating a covariance between the number of counts having the respective energy level associated with the at least one of the energy bins over the discrete time intervals based on the correlations.

29. The system of claim 28, wherein the one or more of the radiation measurement records comprise all of the radiation measurement records contained in the spatial-spectral-temporal database.

30. The system of claim 28, wherein the one or more of the radiation measurement records are associated with locations within a sub-region of the geographic region.

31. The system of claim 27, wherein determining whether the change between the spectral contents of the radiation measurement and the background radiation measurement is consistent with the expected variation in the background radiation measurement further comprises calculating a vector difference.

32. The system of claim 31, wherein the change between the spectral contents of the radiation measurement and the background radiation measurement is consistent with the expected variation in the background radiation measurement under the condition that the vector difference is less than or equal to a predetermined threshold value.

33. The system of claim 31, wherein the change between the spectral contents of the radiation measurement and the background radiation measurement is not consistent with the expected variation in the background radiation measurement under the condition that the vector difference is greater than a predetermined threshold value.

34. The system of claim 32, wherein the predetermined threshold is derived from the expected variation in the background radiation measurement.

35. The system of claim 33, wherein the vector difference is greater than the predetermined threshold value due to an increase in radioactivity within the geographic region.

36. The system of claim 33, wherein the vector difference is greater than the predetermined threshold value due to a decrease in radioactivity within the geographic region.

37. The system of claim 20, wherein the memory has further computer-executable instructions stored thereon that, when executed by the processor, cause the computing device to create and maintain the spatial-spectral-temporal database based on multi-pass radiation measurement surveys performed within the geographic region.

38. The system of claim 37, further comprising a plurality of detection systems, wherein respective detection systems traverse the geographic region on regular or irregular paths to collect the radiation measurements for the multi-pass radiation measurement surveys.

39. The system of claim 20, wherein the memory has further computer-executable instructions stored thereon that, when executed by the processor, cause the computing device to generate an alarm in response to determining that the radiation measurement for the location is anomalous.

40. The system of claim 39, wherein the memory has further computer-executable instructions stored thereon that, when executed by the processor, cause the computing device to transmit the alarm to the detection system.

41. The system of claim 39, wherein the memory has further computer-executable instructions stored thereon that, when executed by the processor, cause the computing device to transmit the alarm to a command center.

42. The system of claim 40, wherein the alarm is configured to trigger at least one of an audio, visual or tactile alarm.
